(19) United States
(12) Patent Application Publication
(10) Pub. No.: US 2017/0253712 A1
(43) Pub. Date: Sep. 7, 2017

(54) Gelation, Aerogel Formation and Reactions Thereof to Produce Non-Random Functionalization of Poly (Aryl Ether Ketones)

(71) Applicant: Virginia Tech Intellectual Properties, Inc., Blacksburg, VA (US)

(72) Inventors: Robert B. Moore, Blacksburg, VA (US); Xijing Yuan, Blacksburg, VA (US)

(73) Assignee: Virginia Tech Intellectual Properties, Inc., Blacksburg, VA (US)

(21) Appl. No.: 15/509,316

(22) PCT Filed: Sep. 8, 2015
(86) PCT No.: PCT/US15/48898

§ 371 Date: Mar. 7, 2017

Related U.S. Application Data
(60) Provisional application No. 62/047,351, filed on Sep. 8, 2014.

(51) Int. Cl. C08J 9/36; C08G 65/48; C08J 9/00; H01M 8/1032; B01D 53/22; B01D 71/52; B01D 71/82; H01M 8/1025; C08G 65/40; C08J 9/28

(52) U.S. Cl. CPC C08J 9/36; C08G 65/4056; C08G 65/48; C08J 9/0071; C08J 9/0076; C08J 9/008; C08J 9/28; B01D 53/228; B01D 71/52; B01D 71/82; H01M 8/1025; H01M 8/1032; C08G 2330/00; C08J 2205/026; C08J 2371/10; C08G 2650/40; H01M 2008/1095

(57) ABSTRACT

The present invention provides a gel comprising a physical network formed of polymer chain crystallites interconnected by amorphous chain segments. Functionalization of the chain segments between the crystallites forms a blocky distribution of functionality along the chain whereby the functionalities are concentrated in groups consisting of one or more functionalities, separated by non-functionalized runs of crystallizable segments of the polymer. Removal of the solvent from the gels, without reducing the gel volume, forms an aerogel.

### RELATED APPLICATIONS

This application claims the benefit of U.S. Provisional Application No. 62/047,351 filed Sep. 8, 2014 and herein incorporated by reference.

### STATEMENT REGARDING FEDERALLY SPONSORED RESEARCH & DEVELOPMENT

Not applicable.

### INCORPORATION BY REFERENCE OF MATERIAL SUBMITTED ON A COMPACT DISC

Not applicable.

### BACKGROUND OF THE INVENTION

Conventional dissolution of crystallizable poly (aryl ether ketone)s, such as poly (ether ether ketone) PEEK, has involved exposure of the polymer to strong acids, such as concentrated sulfuric acid, for extended periods of time. This process is known to cause sulfonation (functionalization) of the polymer backbone during the period of time required to yield a homogeneous solution. Although this functionalization may facilitate the dissolution, U.S. Pat. No. 7,407,609 demonstrates that poly (aryl ether ketone)s can be dissolved in strong acids that are inert to reaction with the polymer, such as methane sulphonic acid. While not commonly recognized in the open literature, PEEK can also be dissolved at elevated temperatures in weak organic acids, such as halogenated acetic acids, which also do not react with the polymer to impart unwanted functionality.

### BRIEF SUMMARY OF THE INVENTION

In one embodiment, the present invention discloses a thermo-reversible gel of poly (ether ether ketone) (PEEK) and a procedure to prepare the gel. The embodiments allow the formation of solvent-extracted aerogels of an engineering thermoplastic for a plurality of applications such as high temperature insulation applications.

In other embodiments, the gels of the present invention allow for the formation of functionalized PEEK bearing a non-random arrangement of functional groups without disrupting the inherent crystallizability of the polymer.

In other embodiments, the gels of the present invention provide functionalized gels comprising sulfonated PEEK with high ion content and crystallinity, which can be further rendered into a membrane form to be used in fuel cell operations, gas purification or gas separation, and liquid purification or separation.

In other embodiments, the gels of the present invention provide methods of thermo-reversible gelation, and aerogel formation thereof by solvent-extraction; and reactions thereof to produce non-random functionalization of poly (aryl ether ketones).

Additional objects and advantages of the invention will be set forth in part in the description which follows, and in part will be obvious from the description, or may be learned by practice of the invention. The objects and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

In the drawings, which are not necessarily drawn to scale, like numerals may describe substantially similar components throughout the several views. Like numerals having different letter suffixes may represent different instances of substantially similar components. The drawings illustrate generally, by way of example, but not by way of limitation, a detailed description of certain embodiments discussed in the present document.

FIGS. 1A and 1B are photographs of a gel made in accordance with an embodiment of the present invention.

### DETAILED DESCRIPTION OF THE INVENTION

Detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a representative basis for teaching one skilled in the art to variously employ the present invention in virtually any appropriately detailed method, structure or system. Further, the terms and phrases used herein are not intended to be limiting, but rather to provide an understandable description of the invention.

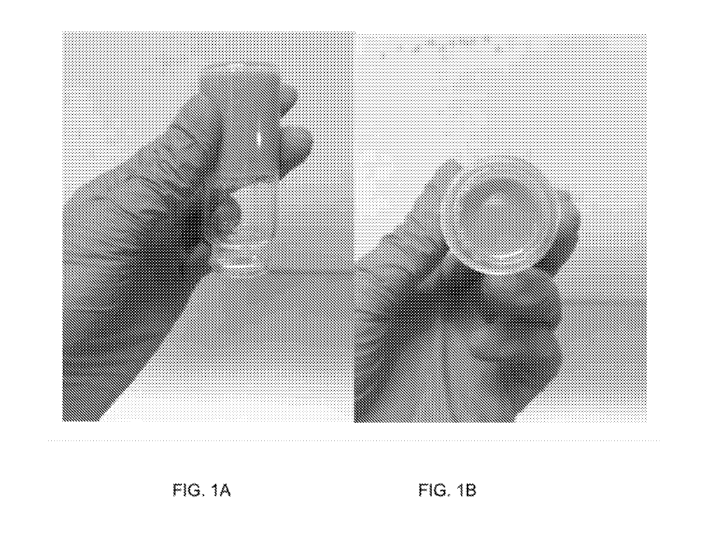

In some embodiments, the present invention is based on a finding that crystallizable poly (aryl ether ketone) solutions at concentrations greater than about 7 wt. % in halogenated acetic acids can be cooled to room temperature, whereby gelation occurs. In a particular embodiment, the preferred gelation time comprises a period of several hours. These stable gels, as shown in FIGS. 1A and 1B, are thermo-reversible in that exposure of the gels to elevated temperatures reconstitutes the solution-state.

Subsequent cooling to a predetermined temperature, such as room temperature, again allows for gel formation.

In yet other embodiments, the physical network of the gels is due to the formation of ordered polymer main-chain crystallites interconnected by solvent swollen amorphous chain segments.

In yet other embodiments, the present invention utilizes water soluble acids, such as halogenated acetic acids, as a weak organic acid to form thermo-reversible gels. As a result, the gels may be solvent exchanged upon exposure to water, especially pure water, whereby the water extracts the acid, including the halogenated acetic acid solvent, from the original gel. The resulting solvent-exchanged gels are transformed into water-swollen gels (also known as hydrogels) without a loss in original volume. The water-swollen, polymer gels may then be transformed into mechanically stable, low-density aerogels following conventional freeze-drying or supercritical carbon dioxide extraction of the water component.

In other embodiments, the solvents used to create the gels are also suitable for the dispersion of nanoparticles such as carbon nanotubes (CNTs), boron nitride nanotubes (BNNTs), and nanoclays (e.g., sodium montmorillonite and organically-modified clays). By adding these dispersed nanoparticles to the polymer solutions, gel nanocomposites may be created that possess a wide variety of enhanced properties.

An additional embodiment of the present invention utilizes the physical gel state of the crystallizable poly (aryl ether ketone)s. Specifically, the embodiment involves the ability to perform chemical reactions on the polymer while in the gel state. In one embodiment, the polymer may be functionalized in a non-random manner by exposing the gel to suitable reactants that do not significantly disrupt the pre-existing gel during the time period of the desired functionalization reaction. By choosing suitable gel-forming solvents, such as dichloroacetic acid, trichloroacetic acid, or other halogenated carboxylic acids, functionalization chemistry, and reaction conditions, a wide range of post-polymerization functionalization reactions may be employed in the gel-state to obtain a unique, non-random, blocky architecture of the resulting functionalized polymer.

Moreover, the gels formed from the suitable gel-forming solvents may be solvent exchanged with other solvents that do not disrupt the gel state to allow for a wider range of functionalization chemistries. The non-random functionalization operation of the embodiment stems from the inaccessibility of the crystalline chain segments within the gel to the chosen reactants.

In the gel state, the solvent swollen amorphous chain segments are accessible to the reactants, and thus functionalization may be sterically limited to chain segments between the preexisting crystallites. In other embodiments, only the solvent swollen amorphous chain segments are accessible to the reactants. The resulting chain architecture of the functionalized polymer may be blocky whereby the functionalities are concentrated in blocks, or condensed groups consisting of one or more functionalities, separated by non-functionalized runs of crystallizable segments of the polymer, which may be pure. The resulting chain architecture of one embodiment of the present is as follows:

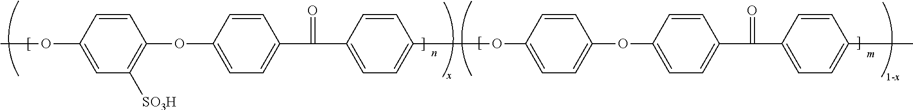

By employing the above-described embodiments of the present invention, it is possible to create highly functionalized polymers that maintain the inherent crystallizability of the parent polymer.

An additional benefit of the present invention is that the same chemical reactions used to functionalize the polymer in the gel-state can be employed prior to gelation. In the homogeneous solution-state, the reactants are accessible to all chain segments, and the resulting functionalization is inherently random along the chain. This allows for the formation of an ideal control system that may be used to compare and contrast the properties of the random and non-random architectures generated from the same parent polymer.

In other embodiments, the PEEK of the present invention may be sulfonated in a non-random fashion by employing a sulfonating reagent that does not significantly disrupt the pre-existing gel during the time period of the desired sulfonation reaction. This blocky sulfonation can then be used for the formation of membrane materials (i.e., sulfonated PEEK) that have a high ion content and high crystallinity.

Conventional methods to produce sulfonated PEEK have all employed a random approach (sulfonation by exposure of PEEK to concentrated sulfuric acid) that effectively destroys the crystallizability of the resulting functionalized polymer. For many membrane applications, such as proton exchange membrane fuel cells (PEMFC) and water purification membranes, it is desirable to have a membrane that possesses both high ion content (to facilitate transport properties) and high crystallinity (to enhance mechanical and thermal stability). By using the blocky architecture created by the present invention, both high functionality and high crystallinity are achieved. For example, a gel-state (non-random) sulfonated PEEK sample containing 32 mol % of sulfonated units yields a degree of crystallinity of 30% (comparable to that of the pure homopolymer). In contrast, a solution-state (random) sulfonated PEEK sample containing 29 mol % of sulfonated units yields only a 4% degree of crystallinity.

In yet other embodiments, the present invention provides a gel comprising a physical network formed of polymer chain crystallites interconnected by amorphous chain segments. The gel may be made by dissolving a polyaryletherketone in a solvent to create a solution. The solution is cooled to form the gel.

In other embodiments, the solvent may be an acid such as a halogenated acetic acid. In other aspects, the gel of the present invention maintains being a gel at room temperature. In addition, the solvent may be a liquid at room temperature. The solvent may also be inert with respect to a sulfonating agent, inert with respect to a functionalizing agent and a non-sulfonating reagent.

In other embodiments, the gel of the present invention is 1% weight to volume, or between 1-20% weight to volume or preferably 5-15% weight to volume (parts per hundreds). The gel may also be comprised of a physical network formed of polymer chain crystallites interconnected by solvent swollen amorphous chain segments. In other aspects, the gel is comprised of a physical network formed of ordered polymer main-chain crystallites interconnected by solvent swollen amorphous chain segments. In addition, the polymer chain crystallites may be inert, the polymer chain segments within said crystallites may be inert, and the polymer chain segments within said crystallites are inert as a result of being sterically inaccessible.

The functionalization of the gel may be sterically limited to amorphous chain segments between and covalently attached to the crystallites. The functionalization of the chain segments between the crystallites may also form a blocky distribution of functionality along the chain whereby the functionalities are concentrated in groups consisting of one or more functionalities, separated by non-functionalized runs of crystallizable segments of the polymer.

In other embodiments, the gel of the present invention may further include a reinforcing material. The reinforcing material may be at least one type of nano-size filler, which may be nanoparticles, nanotubes nanoclays, nano-fibers, or nano-sheets.

To assist in gel formation, a nucleation agent may be used. A nucleation agent that may be used is a nano-size filler, such as nanoparticles, nanotubes nanoclays, nano-fibers, or nano-sheets.

In yet other embodiments, the functionalized Polyaryletherketone blocky copolymer comprises a polymer segment having a functional group and a polymer segment having substantially no functional group, wherein the functionalized Polyaryletherketone is made by post-functionalization of a Polyaryletherketone gel. The functionalized Polyaryletherketone blocky copolymer may also be a non-random sulfonated block copolymer of Polyaryletherketone. In yet other embodiments, the functionalized Polyaryletherketone blocky copolymer is made by post-functionalization of the Polyaryletherketone gel.

In still further embodiments, the gel is an aerogel, a hydrogel, or a solvent exchanged gel. In addition, the gel may be an aerogel of Polyaryletherketone. The aerogel may be formed by solvent-extraction of the Polyaryletherketone. Uses for the aerogel include use as a material for high temperature insulation. In other aspects, the gel or the aerogel of the present invention may be formed into a membrane, thin film, coating, foam, or solid form. The membranes may further be used as fuel cells, gas separation and/or purification, or liquid separation and/or purification.

In other aspects, the present invention provides a method of adding one or more functional groups to an engineering thermal plastic comprising the steps of: dissolving the engineering thermal plastic, forming a gel from the engineering thermal plastic solution, adding one or more functionalizing reagents to the gel, reacting the gel and reagent to form a functionalized gel. The gel created may be an aerogel and the thermoplastic may be a Polyaryletherketone. Functionalization may be achieved by reacting the gel with a reactive agent capable of covalently attaching one or more functional groups to the amorphous chain segments. The covalently attached functional groups may be acids, salts, alcohols, amines, halogens, or other halogenated species. In addition, the functional groups may be further reacted with suitable reagents to convert the original functionalities to other functionalities.

In yet other embodiments, the present invention provides a gel of functionalized Polyaryletherketone block copolymer comprising a polymer segment having functional groups and a polymer segment having substantially no functional group, wherein the functionalized Polyaryletherketone is made by post-functionalization of the Polyaryletherketone gel. In still further embodiments, the present invention provides a functionalized Polyaryletherketone block copolymer comprising a polymer segment having functional groups and a polymer segment having substantially no functional group, wherein the functionalized Polyaryletherketone is made by post-functionalization of the Polyaryletherketone gel.

While the foregoing written description enables one of ordinary skill to make and use what is considered presently to be the best mode thereof, those of ordinary skill will understand and appreciate the existence of variations, combinations, and equivalents of the specific embodiment, method, and examples herein. The disclosure should therefore not be limited by the above described embodiments, methods, and examples, but by all embodiments and methods within the scope and spirit of the disclosure.

What is claimed is:

1. A gel comprising a physical network formed of polymer chain crystallites interconnected by amorphous chain segments.

2. The gel of claim 1 made by dissolving a polyaryletherketone in a solvent to create a solution and cooling said solution to form said gel.

3. The gel of claim 2 wherein said solvent is an acid.

4. The gel of claim 2 wherein said solvent is a halogenated acetic acid.

5. The gel of claim 2 wherein said gel maintains being a gel at room temperature.

6. The gel of claim 2 wherein said solvent in said gel is a liquid at room temperature.

7. The gel of claim 2 wherein said solvent is inert with respect to a sulfonating agent.

8. The gel of claim 2 wherein said solvent is inert with respect to a functionalizing agent.

9. The gel of claim 1 wherein said gel is 1% polymer by weight to volume.

10. The gel of claim 3 wherein said solvent is a non-sulfonating reagent.

11. The gel of claim 2 comprising a physical network formed of polymer chain crystallites interconnected by solvent swollen amorphous chain segments.

12. The gel of claim 11 comprising a physical network formed of ordered polymer main-chain crystallites interconnected by solvent swollen amorphous chain segments.

13. The gel of claim 1 wherein said polymer chain crystallites are inert.

14. The gel of claim 13 wherein polymer chain segments within said crystallites are inert.

15. The gel of claim 13 wherein polymer chain segments within said crystallites are inert as a result of being sterically inaccessible.

16. The gel of claim 1 wherein functionalization of said gel is sterically limited to amorphous chain segments between and covalently attached to said crystallites.

17. The gel of claim 1 wherein functionalization of said chain segments between said crystallites forms a blocky distribution of functionality along the chain whereby the functionalities are concentrated in groups consisting of one or more functionalities, separated by non-functionalized runs of crystallizable segments of the polymer.

18. The gel of claim 17 further including a reinforcing material.

19. The gel of claim 18 wherein the reinforcing material is at least one type of nano-size filler.

20. The gel of claim 18 wherein the nano-size filler are nanoparticles, nanotubes nanoclays, nano-fibers, or nano-sheets.

21. The gel of claim 1 further including a nucleation agent to assist in gel formation.

22. The gel of claim 21 wherein the nucleation agent is at least one type of nano-size filler.

23. The gel of claim 21 wherein the nucleation agents are nanoparticles, nanotubes nanoclays, nano-fibers, or nano-sheets.

24. The gel of claim 1 made by a functionalized Polyaryletherketone blocky copolymer comprising a polymer segment having a functional group and a polymer segment having substantially no functional group, wherein the functionalized Polyaryletherketone is made by post-functionalization of a Polyaryletherketone gel.

25. The gel of claim 24 wherein the functionalized Polyaryletherketone blocky copolymer is a non-random sulfonated block copolymer of Polyaryletherketone.

26. The gel of claim 24 wherein the functionalized Polyaryletherketone blocky copolymer is made by post-functionalization of the Polyaryletherketone gel.

27. The gel of claim 24 wherein the gel is an aerogel.

28. The gel of claim 24 wherein the gel is an hydrogel.

29. The gel of claim 24 wherein the gel is a solvent exchanged gel.

30. The gel of claim 27 wherein the gel is an aerogel of Polyaryletherketone.

31. The aerogel of claim 27 wherein the aerogel is formed by solvent-extraction of the Polyaryletherketone.

32. The aero gel of claim 27 wherein the aerogel is used as a material for high temperature insulation.

33. The gel of claim 27 wherein the gel is an aerogel of Polyaryletherketone.

34. The sulfonated Polyaryletherketone of claim 24 is formed into a membrane, thin film, coating, foam, or solid form.

35. The membrane of claim 34 wherein the membrane is used for fuel cell, gas separation and/or purification, or liquid separation and/or purification.

36. The gel of claim 1 made from Polyaryletherketone and at least one weak organic acid.

37. A method of adding one or more functional groups to an engineering thermoplastic comprising the steps of: dissolving the engineering thermoplastic, forming a gel from the engineering thermoplastic solution, adding one or more functionalizing reagents to the gel, reacting said gel and reagent to form a functionalized gel.

38. The method of claim 37 wherein the gel is an aerogel.

39. The method of claim 37 wherein the thermoplastic is Polyaryletherketone.

40. The method of claim 37 wherein functionalization is achieved by reacting said gel with a reactive agent capable of covalently attaching one or more functional groups to the amorphous chain segments.

41. The method of claim 40 wherein said covalently attached functional groups may be acids, salts, alcohols, amines, halogens, or other halogenated species.

42. The method of claim 37 wherein the functional groups may be further reacted with suitable reagents to convert the original functionalities to other functionalities.

43. A gel of functionalized Polyaryletherketone block copolymer comprising a polymer segment having functional groups and a polymer segment having substantially no functional group, wherein the functionalized Polyaryletherketone is made by post-functionalization of the Polyaryletherketone gel of claim 1.

44. A functionalized Polyaryletherketone block copolymer comprising a polymer segment having functional groups and a polymer segment having substantially no functional group, wherein the functionalized Polyaryletherketone is made by post-functionalization of the Polyaryletherketone gel of claim 1.

45. The gel of claim 1 wherein said gel is between 1-20% weight to volume.

46. The gel of claim 1 wherein said gel is between 5-15% weight to volume.

47. The gel of claim 1 further including a reinforcing material.

48. The gel of claim 47 wherein the reinforcing material is at least one type of nano-size filler.

49. The gel of claim 48 wherein the nano-size filler are nanoparticles, nanotubes nanoclays, nano-fibers, or nano-sheets.
